(19) United States
(12) Patent Application Publication
(10) Pub. No.: US 2013/0162901 A1
(43) Pub. Date: Jun. 27, 2013

(54) RINGING SUPPRESSION IN VIDEO SCALERS

(71) Applicant: Laurence A. Thompson, Saratoga, CA (US)

(72) Inventor: Laurence A. Thompson, Saratoga, CA (US)

(73) Assignee: Silicon Image, Inc., Sunnyvale, CA (US)

(21) Appl. No.: 13/335,398

(22) Filed: Dec. 22, 2011

(51) Int. Cl. H04N 7/01

(52) U.S. Cl. 348/441; 348/E07.003

(57) ABSTRACT

Embodiments are generally directed to ringing suppression in video scalers. An embodiment of a method includes receiving a stream of video data, received video data including sets of video data values, and storing a first set of video data values in a memory. A first set of scaled values for the set of video data values is determined based on a scaling technology, and a second set based on linear interpolation. The method includes detecting rate of change in amplitude for received video data, generating a mixing control signal based at least in part on the rate of change, mixing first set of scaled values and second set of scaled values based at least in part on mixing control signal to generate blended set of coefficients, and generating scaled video data output using the set of blended values.

### TECHNICAL FIELD

Embodiments of the invention generally relate to the field of electronic data communications and, more particularly, to ringing suppression in video scalers.

### BACKGROUND

In the presentation of video images in electronic devices, it is often required that the scale of a stream of video data be modified in order to display the image in a particular system. A circuit, element, or module to change the scale of a stream of video data is referred to herein generally as a “scaler”,

A scaler may utilize numerous different technologies. However, certain scaling technologies may generate “filter ringing” (also referred to herein as “ringing”). Ringing is caused by rapid changes in the input data, i.e., a change in the input that has both high energy and high frequency. Such changes in the input signal are relatively rare for natural images (images that are generated by cameras), and thus ringing is generally a less pronounced problem when scaling such video data. However, graphic images from computer sources often include rapid change characteristics that may cause ringing. Because graphics elements are often mixed or overlaid onto video images, the ringing caused by the utilized scaling technology may be objectionable to a viewer, and thus diminishes the performance characteristics of the technology.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is an illustration of an embodiment of a multimedia apparatus or system including an adaptive scaler;

FIG. 2 is an illustration of an embodiment of an adaptive scaler;

FIG. 3 illustrates of an embodiment of a section of a vertical scaler;

FIG. 4A illustrates an embodiment of a section of a vertical scaler including rate of change detection and coefficient mixing;

FIG. 4B illustrates an embodiment of a section of a vertical scaler including scalers operating in parallel;

FIG. 5 illustrates an embodiment of a portion of a rate of change detection module;

FIG. 6 illustrates an embodiment of a portion of a rate of change detection module;

FIG. 7 is a flow chart to illustrate an embodiment of a process for generation of scaled video data;

FIG. 8 illustrates an FIR digital filter in an embodiment of a scaling apparatus or system;

FIG. 9 illustrates modification of sampling rate in an embodiment of a video scaling process, apparatus, or system;

FIG. 10 illustrates modification of a sample rate of an FIR filter by decimation in an embodiment of a scaling process, apparatus, or system;

FIG. 11 illustrates modification of a sample rate of an FIR filter by interpolation in an embodiment of a scaling process, apparatus, or system;

FIG. 12A illustrates modification of a filter operation by a sampling ratio in an embodiment of a system;

FIG. 12B illustrates a system for modification of a filter operation by a sampling ratio;

FIG. 13 illustrates a polyphase FIR digital filter providing input flow control in an embodiment of a scaling process, apparatus, or system;

FIG. 14 illustrates a polyphase FIR filter providing input and output flow control in an embodiment of a scaling process, apparatus, or system;

FIG. 15 illustrates a phase accumulator in embodiment of a video scaling process, apparatus, or system;

FIG. 16 illustrates a sequence of input samples to an embodiment of a video scaler;

FIG. 17A illustrates an input sequence processed by a video scaler including a polyphase FIR filter; and

FIG. 17B illustrates an input sequence processed by a video scaler including a linear interpolator.

### SUMMARY

Embodiments of the invention are generally directed to ringing suppression in video scalers.

In a first aspect of the invention, an embodiment of a method includes receiving a stream of video data, where the received video data includes sets of video data values, and storing a first set of video data values from the stream of video data in a memory. A first set of scaled values is determined for the set of video data values based on a scaling technology, and a second set of scaled values for the set of video data values based on linear interpolation of the video data. The method further includes detecting a rate of change in amplitude for the received video data, generating a mixing control signal based at least in part on the rate of change of the video data, mixing the first set of scaled values and the second set of scaled values based at least in part on the mixing control signal to generate a blended set of coefficients, and generating a scaled video data output using the set of blended values.

In a second aspect of the invention, an embodiment of an apparatus includes a memory to store sets of video data values from a video data stream, and a scaled value determination portion to determine a first set of scaled values for scaling of the video data stream using a video scaling technology. The apparatus further includes a detection element to determine a rate of change in amplitude of the video data stream and to determine a mixing control signal based on the determined rate of change, and a mixing element to mix the first set of scaled values with a second set of coefficients based on linear interpolation to generate a set of blended values.

### DETAILED DESCRIPTION

Embodiments of the invention are generally directed to ringing suppression in video scalers.

In some embodiments, a method, apparatus, or system provides for ringing suppression in video scalers. In some embodiments, a method, apparatus, or system for video scaling includes implementation of linear interpolation with a scaling technology, such as a technique utilizing a poly-phase filter, to reduce the ringing generated by the video scaling.

Video scaling is a signal processing function that is used to resizing or changing resolution of a digital video image. Often, video scaling is required to convert video formats. Format conversion is commonly performed in television sets and other digital displays, or is performed in video source devices such as DVD players, BluRay players, or broadcast set-top boxes.

In an example, a DVD optical disc may store a motion picture as a compressed file. To play back the stored motion picture, a DVD player reads data from the optical disc and performs de-compression processing, which will yield a standard definition video signal. Standard definition video typically has a resolution of 720×480 (for 60 Hz video standards), or 720×576 (for 50 Hz standards) pixels per frame.

A standard definition video signal may be displayed on a high definition display by performing format conversion, and the format conversion processing typically requires video scaling. For example, one common resolution used in high definition displays 1920×1080 pixels per frame. The standard definition video signal is converted from resolution of 720×480 to a resolution to 1920×1080 to be viewable on the high definition display. This conversion is performed by a video scaler.

A “scaling ratio” refers to the ratio the output of a video scaler divided by the input. Often, it is convenient to express this as a “vertical scaling ratio” and a “horizontal scaling ratio. For the example used in the previous paragraph, a scaler that converts an input video signal with a resolution of 720×480 to an output resolution of 1920×1080 uses the following ratios:

$$\begin{matrix}Vertical Scaling Ratio = ( vert . output resolution ) / ( vert . input resolution ) \\ = 1080 / 480\end{matrix}$$

$$\begin{matrix}Horizontal Scaling Ratio = ( horiz . output resolution ) / ( horiz . input resolution ) \\ = 1920 / 720\end{matrix}$$

From this example, it can be seen that the scaling ratios are ratios of integers, and that horizontal and vertical scaling may require different scaling ratios. Furthermore, many different resolutions are used both for signals and for displays, and, in addition to converting standard video formats, a video scaler may also be used to implement user controls that require scaling video, including zoom, underscan, and aspect ratio corrections. For this reason, a commercially viable video scaler may be required to provide sufficient programmability to perform a scaling over a range of scaling ratios.

Video images are composed arrays of individual picture elements or pixels. Pixels are digital samples of a video signal, and video scaling is an application of digital sampling rate conversion.

In some embodiments, a video scaler utilizing a certain scaling technology may include a rate of change detection module or element to detect rate of change in the data and to generate mixing control signals. In some embodiments, a video scaler may include a coefficient mixer module or element to generate scaled values, such as linear interpolation coefficients or luma values, and to mix the linear interpolation scaled values with scaled values generated or obtained for the chosen scaling technology based upon the mixing control signals for suppression of filter ringing. While the discussion herein regarding the rate of change detection and coefficient mixing generally refers to two modules or elements, embodiments are not limited to this format, and may; for example, include a single module or element providing the detection and mixing functions, or more than two modules or elements providing the detection and mixing functions.

There are multiple different technologies that may be used for scaling or resizing video images. Common scaling technologies include, but are not limited to: (1) Nearest neighbor (pixel replication); (2) Linear interpolation, and hi-linear Interpolation (where “bi” prefix indicates two-dimensional interpolation)—Calculating pixels on a straight-line segment between given pixels (or sample points); (3) Cubic and bi-cubic interpolation—Using a polynomial to calculate interpolated pixel values. There are numerous other related methods that use polynomials, including Hermite Interpolation and Catmull-Rom Splines. However, these are only examples of mathematical methods employing polynomials, and do not describe an exhaustive list of possible methods that employ polynomials; and (4) Poly-phase filter bank—A poly-phase filter bank is a technology that is related to Fourier analysis, where an apparatus, system, or process provides for computing frequency components of set of data samples, and computing an output sample based on the frequency and the input-to-output phase relationship.

The scaling technologies provided above are generally listed in order from simplest to most complex, and from the lowest to highest in terms of output image quality. The cost of implementation, in terms of logic requirements, computation time, power consumption, and other factors, also generally follow this ordering.

Among the possible technologies, poly-phase filter banks have numerous advantages when used for video scaling, including high performance and flexibility. However, under certain conditions, a poly-phase filter can introduce unwanted artifacts in the output image. The existence of these artifacts referred to as “filter ringing” (or “ringing”) is a common problem in filters of this type. In the language of digital signal processing, the ringing in poly-phase filters is known as the “Gibbs Phenomenon.” Further, ringing is also possible with other polynomial techniques, where the result is referred to as “Runge's Phenomenon.”

In some embodiments, a video scaler, such as a poly-phase filter bank based scaler, includes elements for the suppression of filter ringing. In some embodiments, the scaler includes:

(1) Computation of a phase of an output pixel relative to an input sampling grid.

(2) Utilizing the computed phase information to determine a set of scaled values such as coefficients for the poly-phase filter, where the coefficients may be determined by, for example, calculating the set of coefficients or looking up pre-computed coefficients for the poly-phase filter.

(3) Utilizing the computed phase information to determine a set of linear interpolation coefficients, where the coefficients may be determined by, for example, calculating the set of coefficients or looking up pre-computed linear interpolation coefficients.

(4) Computing a rate of change in amplitude of a set of input samples.

(5) Generating a rate of change (ROC) multi-bit digital signal from the computation of the rate of change in amplitude.

(6) Using the rate of change signal as a mixing control for blending the linear interpolation coefficients with the poly-phase filter coefficients,

(7) Using the blended coefficients in the poly-phase filter to compute an output pixel.

In some embodiments, a process for mixing linear interpolation coefficients with coefficients for a scaler technology may be utilized to improve a video scaler that is based on a poly-phase filter bank by reducing ringing in the output of the scaler. However, embodiments are not limited to a poly-phase filter bank, and in some embodiments, the technology may further be applied to other high performance video scaler designs, and to polynomial techniques,

Computer generated images have characteristics that may cause ringing in the scaled images. Abrupt transitions, such as full-scale transitions over the space of a single pixel, are common with computer graphics, though rare in natural images. In this context, “computer sources” includes computers, consumer electronics devices that generate video signals, such as DVD players, AV receivers, video set-top boxes, and other computing systems, where the graphics images may include, but are not limited to, elements such as menus and icons. Such features in graphics may cause a poly-phase filter based scaler to ring. In addition, white less common, there are certain cases where ringing occurs at objectionable levels with natural images, such as along the edges of “black bars” where the ringing appears as a straight line.

In some embodiments, a universal scaling technology provides for reduction in ringing, while maintaining quality for scaled natural images. In some embodiments, features of the scaling technology include:

(1) A modular design, allowing for addition of the technology to known scalers, such as YCbCr 4:2:2 scalers or 4:4:4/RGB scalers,

(2) independent operation for horizontal and vertical scalers.

(3) Scaler operation such that additional line memory is not required, with the scaler being relatively simple in operation.

(4) The scaler may be self-adaptive to image characteristics, with the scaler further including simple software controls to adjust performance.

in some embodiments, a scaler operates by modifying the scaling filter's characteristic in active operation based on the content of the incoming image. In some embodiments, the universal scaler performs this operation by mixing standard filter coefficients that are generated or retrieved (such as, for example, coefficients stored in read-only memory (ROM)) with a set of coefficients that are generated internally using phase information from an accumulator. In some embodiments, the internally generated coefficients may be linear interpolator (LI) coefficients.

An advantage of a linear interpolator is that the linear interpolator generally will not produce ringing in an image. However, a linear interpolator, when used as a scaler, generally does not produce the same level of image quality as produced by a poly-phase filter. In some embodiments, by intelligent blending of the two sets of scaled values such as coefficients, a universal scaler may take advantage of characteristics of the linear interpolator and the poly-phase filter to produce a high quality output with reduced ringing.

FIR (Finite Input Response) digital filters may be utilized in numerous signal applications. An FIR digital filter is a frequency selective structure, allowing a band of frequencies to pass to the output while attenuating a different band of frequencies. An FIR digital filter may be designed for a low-pass, high pass, band-pass, or band-reject filtering function, although it is not limited to these basic types. Among other uses, low pass FIR filters may be used for video scaling, and low-pass filter responses are described here.

In practice, an FIR digital filter may be implemented in multiple forms, such as a software program or as a hardware design built of common logic elements. The description provided here is generally provided from the perspective of a hardware implementation.

The concept of a polyphase FM filter is utilized in the field of digital signal processing as a means for performing digital sampling rate conversion. A polyphase FIR filter works well as an algorithm for scaling digital video. It may be utilized as an efficient and cost effective structure that generally produces good quality output images.

However, polyphase FIR filters are imperfect. Certain conditions may reveal distortions in the output of a polyphase FIR filter when it is used for video scaling.

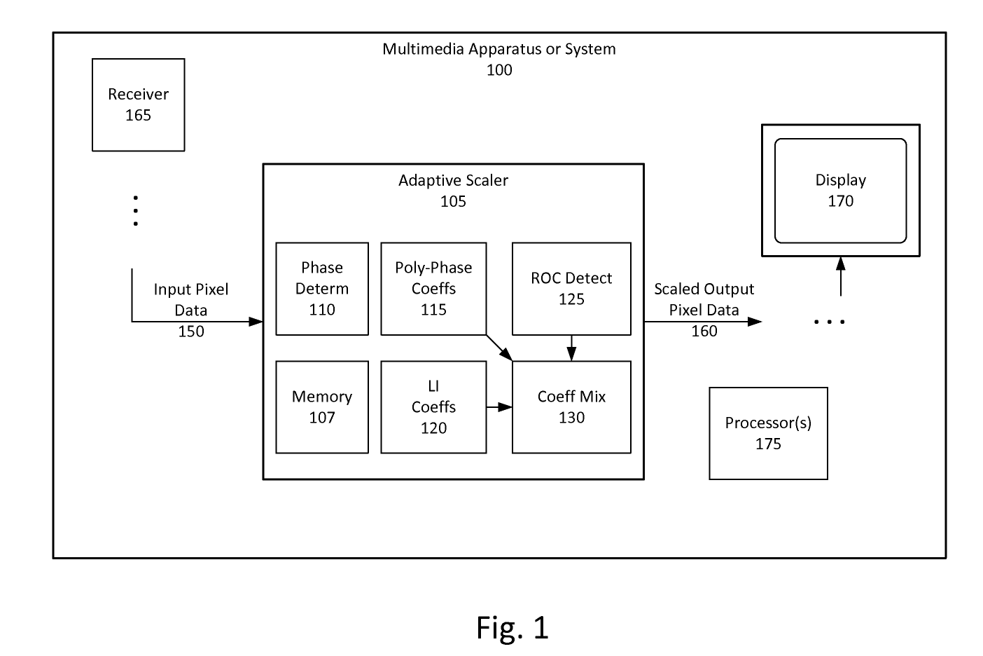

FIG. 1 is an illustration of an embodiment of a multimedia apparatus or system including an adaptive scaler. In this illustration, a simplified apparatus or system is provided, with the illustration not including known elements of a multimedia system. In some embodiments, the system receives, such as via receiver 165, or generates certain video data 150, where scaling is needed to generate scaled video data 160 for a display 170 (which may or may not be a part of the apparatus or system 100) or handling by one or elements, such as one or more processors 175. In some embodiments, the apparatus or system 100 includes an adaptive scaler 105 to respond to changes in the video data and reduce filter ringing.

In some embodiments, the adaptive scaler 105 includes a memory 107 to store a certain number of received video data elements, and an element to determine a phase of pixel data relative to an input sampling grid 110. In some embodiments, the scaler 105 utilizes the computed phase information to determine a set of poly-phase filter coefficients 115.

in some embodiments, the scaler further determines a set of linear interpolation filter coefficients 120. In some embodiments, the scaler 105 includes an element or module 125 to determine a rate of change (ROC) in amplitude of a set of input samples and to generate a rate of change signal from the determined rate of change in amplitude. In some embodiments, the scaler includes a coefficient mixing element or module 130, where the coefficient mixing element 130 utilizes the rate of change signal as a mixing control for blending the linear interpolation filter coefficients with the poly-phase filter coefficients. In some embodiments, the scaler utilizes the resulting blended coefficients in the poly-phase filter to compute a scaled output pixel 160 for presentation on the display 170.

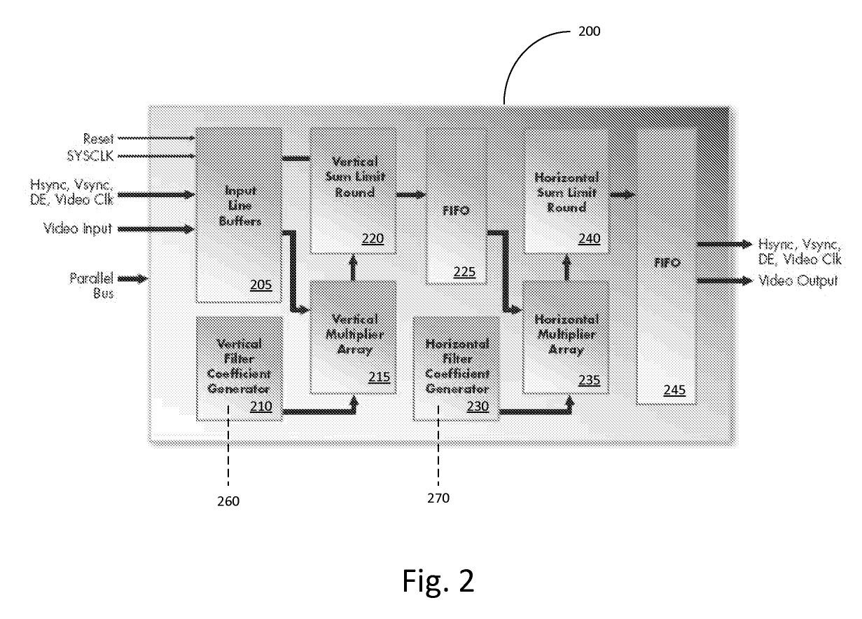

FIG. 2 illustrates an embodiment of an adaptive scaler. In some embodiments, the adaptive scaler 200 may utilize poly-phase filtering in the scaling of video data. In some embodiments, the scaler 200, which may connected via a parallel bus, includes input line buffers 205 for the receipt of a video input, together with signals Hsync, Vsync, DE, and video clock. The input line buffers 205 may further receive a system clock signal (SYSCLK) and a reset signal.

In FIG. 2, the sealer 200 further includes filter coefficient generation, shown as a vertical filter generator 210 and a horizontal filter coefficient generator 230. As illustrated, the data from the input line buffers 205 and the generated blended coefficients from the vertical coefficient generator 210 are multiplied by a vertical multiplier array 215, with the products of the multiplication being received by an element to sum the products, limit overflow, and round to a certain number of bits 220, the resulting vertically scaled data to be held by a FIFO buffer 225. The data from the FIFO buffer 225 and the generated coefficients from the horizontal coefficient generator 230 are multiplied by a horizontal multiplier array 235, with the products of the multiplication being received by an element to sum the products, limit overflow, and round to a certain number of bits 240, the resulting vertically and horizontally scaled data to be held by a second FIFO buffer 245. The scaler outputs the video output, together with signals Hsync, Vsync, DE, and video clock.

In some embodiments, the vertical coefficient generator 210 and the horizontal coefficient generator 230 include elements (260 and 270 respectively) for generation of linear interpolation coefficients, determination of a rate of change of the video data, and mixing of the poly-phase filter coefficients with the linear interpolation coefficients based at least in part on the determination of the rate of change of the video data. In some embodiments, the scaler may utilize the elements 260-270 to reduce filter ringing created by the poly-phase filter bank. The operation of the elements is described in more detail below.

In some embodiments, mixer operations may include the following functions:

(1) Calculation of linear interpolator scaled values from an accumulator's phase information.

(2) Value mixing, where a mixing control signal from a rate of change detection module is utilized to mix poly-phase scaled values with linear interpolator scaled values and generate a set of blended values.

In some embodiments, a module includes a ringing control register (RCR). In some embodiments, the ringing control register is a software programmable register and is in the form of a mixed number, such as an integer and fraction. For example, the register may be a minimum of eight bits (four bits for the integer and 4 bits for the fraction). In some embodiments, a first RCR is utilized for the vertical scaler Y channel and a second RCR is utilized for the horizontal scaler Y channel.

in some embodiments, ringing suppression may be applied to chroma as an option. In an example, for a 4:2:2 scaler, a separate RCR may be provided for the vertical chroma scaler. In some embodiments, ringing suppression for the horizontal chroma scaler may not be necessary in a 4:2:2 scaler. In another example, for a 4:4:4 scaler, ringing suppression may be applied to chroma in both the vertical and horizontal sections.

In some embodiments, certain signals provide for a “special case” in the calculations at the top, bottom, left and right edges of the display. In an example, if input Y3 is the current input where Y3 is near an edge, there may not be values for all six of the other Y inputs. In some embodiments, values are provided for that the inputs that have no values, such as substituting zeros in place of the missing data.

In some embodiments, an output is a mixing control signal, which may be, for example, an eleven bit binary number, in the range 0>1.0, so that the maximum value for mixingControl is 1.0000000000 in binary format.

In some embodiments, the operation of a rate of change detection module or element includes the following:

(1) Maximum Difference—In some embodiments, the maximum difference may be determined as follows:

maxDifference=Max[Abs[Y1−Y0], Abs[Y2−Y1], Abs[Y3−Y2], Abs[Y4−Y3], Abs[Y5−Y4], Abs[Y6−Y5]]; [1]

where:
Max[ ] is a function that finds the maximum value from a list of values
Abs[ ] is a an Absolute Value Function
Y0 thru Y6 are seven Y values from the line memories

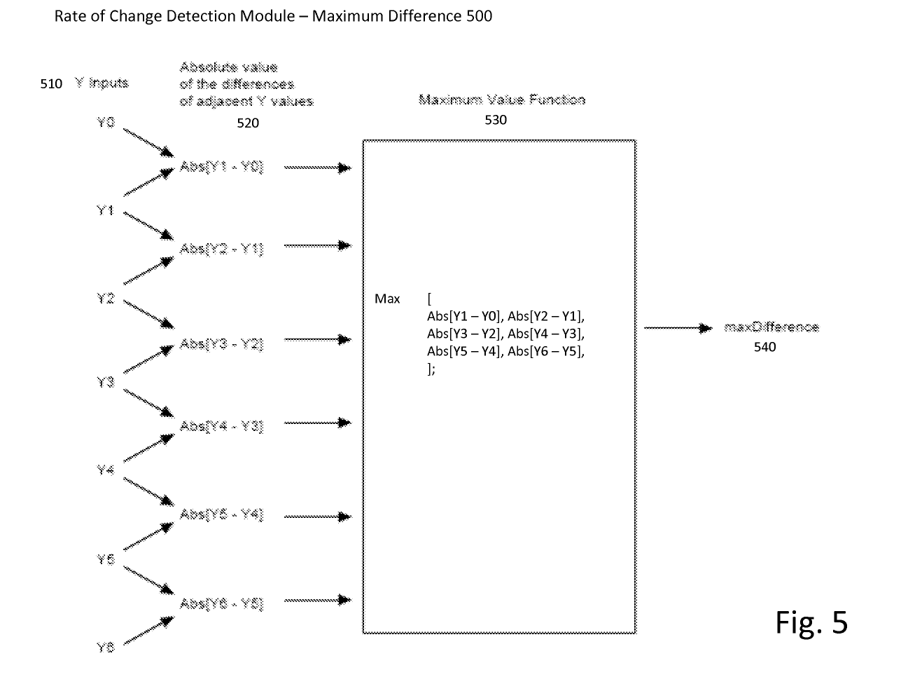

An embodiment of the determination of the maximum difference by the rate of change detection module is provided in FIG. 5, described below.

(2) Sum of Differences—In some embodiments, the sum of differences may be determined as follows:

Sum=Abs[Y1−Y0]+Abs[Y2−Y1]+Abs[Y3−Y2]+Abs[Y4−Y3]+Abs[Y5−Y4]+Abs[Y6−5] [2]

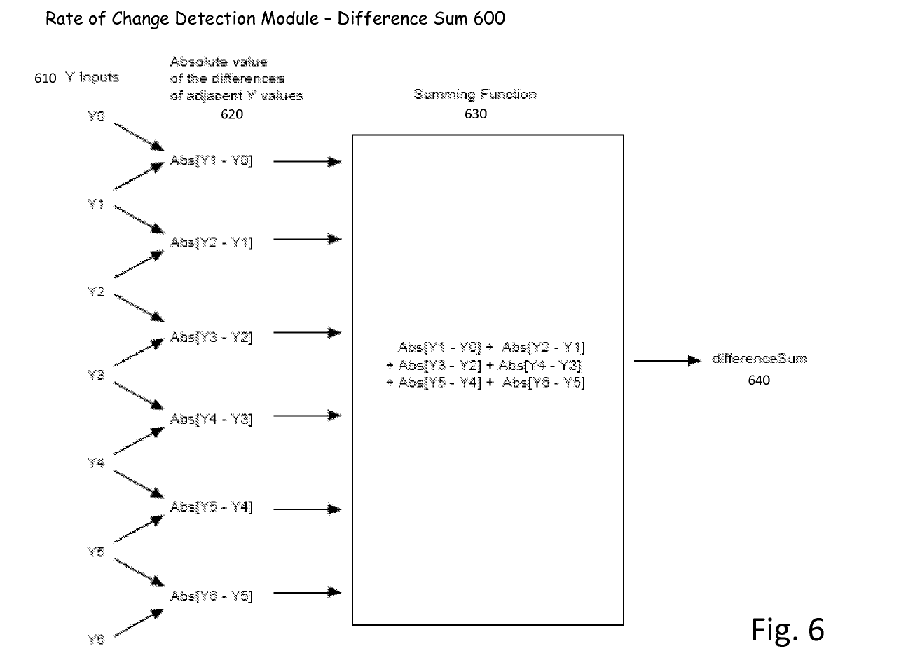

An embodiment of the determination of the sum of differences by the rate of change detection module is provided in FIG. 6, described below.

(3) Difference ratio—In some embodiments, a difference ratio (differenceRatio) is determined utilizing the maxDifference and differenceSum as follows:

IF differenceSum=0

THEN differenceRatio=0

ELSE differenceRatio=maxDifference/differenceSum

The IF statement above insures that the calculation does not provide for dividing by zero. The differenceSum will be zero when Y0=Y1=Y2=Y3=Y4=Y5=Y6

(4) Output of Module—In some embodiments, the output of the rate of change detection module (mixingControl) is determined from the differenceRatio, RCR, and maxDifference, as follows:

mixingControl=maxDifference×RCR×differenceRatio [3]

In some embodiments, if the calculation for mixingControl produces a number larger than 1.0, the result is limited to 1.0. Thus, the binary value of mixingControl does not exceed 1.0000000000 (binary).

In some embodiments, the operation of a mixer module includes receiving scaled value inputs, such as inputs from the scaler's coefficient ROM or from calculated coefficients, and the receipt of mixing control information from the rate of change detection module. In some embodiments, the mixer module further provides for the generation of linear interpolation coefficient data from received phase information, where the received phase information may be, for example, a certain portion of an accumulator register. In some embodiments, the mixer modules operates to produce blended values based upon the received scaled value input data, the generated linear interpolation scaled value data, and the received mixing control data.

In some embodiments, the inputs to the mixer module may be:

(a) Coefficient values from the coefficient ROM or other determination of coefficients may be expressed as follows:

Coefficients=C0, C1, C2, C3, C4, C5, C6

(b) Fractional portion of the scaler's accumulator register, such as, for example, the lower 17 bits of the accumulator register, such data providing the phase information for determination of linear interpolation data.

(c) Mixing control signal from the rate of change module that controls coefficient mixing.

In some embodiments, the output of the coefficient mixer modules may be the following:

Blended Coefficients=BC0, BC1, BC2, BC3, BC4, BC5, BC6

In some embodiments, the operation of a mixer module or element includes the following:

(1) Generate linear interpolator coefficients from the accumulator's phase information—The linear interpolation coefficients may be designated as Li0, Li1, Li2, Li3, Li4, Li5, and Li6. In some embodiments, certain of the linear interpolation coefficients will be zero, such as Li0=Li1=Li5=Li6=0, and thus these elements do not need to be determined, with the module operating to determine the remaining coefficients, Li2, Li3, and Li4.

In some embodiments, the phase for a linear interpolator (LIphase) is the sum of a phase value and an offset value, such as the following:

LIphase=phase+offset [6]

where:
Phase=the fractional part of the scaler's accumulator. In an example, for a 119-bit accumulator, the phase equals the lower 17 binary bits of the accumulator value.
Offset=a constant, which in this illustration is equal to 1/62. When converted to a 17 bit binary fraction, 1/62=0.00000100001000010

In this illustration, both “phase” and “offset” are 17-bit fractions. In calculation, it is possible that the add operation can generate a carry into the integer portion of the result. In other words, the addition of the two fractions may sum to a number that is equal to or greater than 1.0. If this occurs, the result may still be utilized in calculation.

In some embodiments, the determination of the mixing equation produces three coefficients, where one of the coefficients is zero. The remaining two coefficients are considered fractions whose sum is 1.0. In some embodiments, the dynamic range of the LI coefficients are 10 bits or higher.

In some embodiments, the determination of the coefficients is as follows:

IF [ LIphase <= 0.5
THEN:

Li2 = 0.5 − LIphase
Li3 = LIphase + 0.5
Li4 = 0

ELSE:

Li2 = 0
Li3 = 1.5 − LIphase
Li4 = LIphase − 0.5

]

(2) Determination of the blended coefficients—In some embodiments, the blended coefficients are determined based upon the received coefficients and the mixing control as follows:

BC0=(1−mixingControl)×C0

BC1=(1−mixingControl)×C1

BC2 ((1−mixingControl)×C2)+(mixingConrol×Li2)

BC3=((1−mixingControl)×C3)+(mixingControl×Li3)

BC4=((1−mixingControl)×C4)+(mixingControl×Li4)

BC5=(1−mixingControl)×C5

BC6=(1−mixingControl)×C6

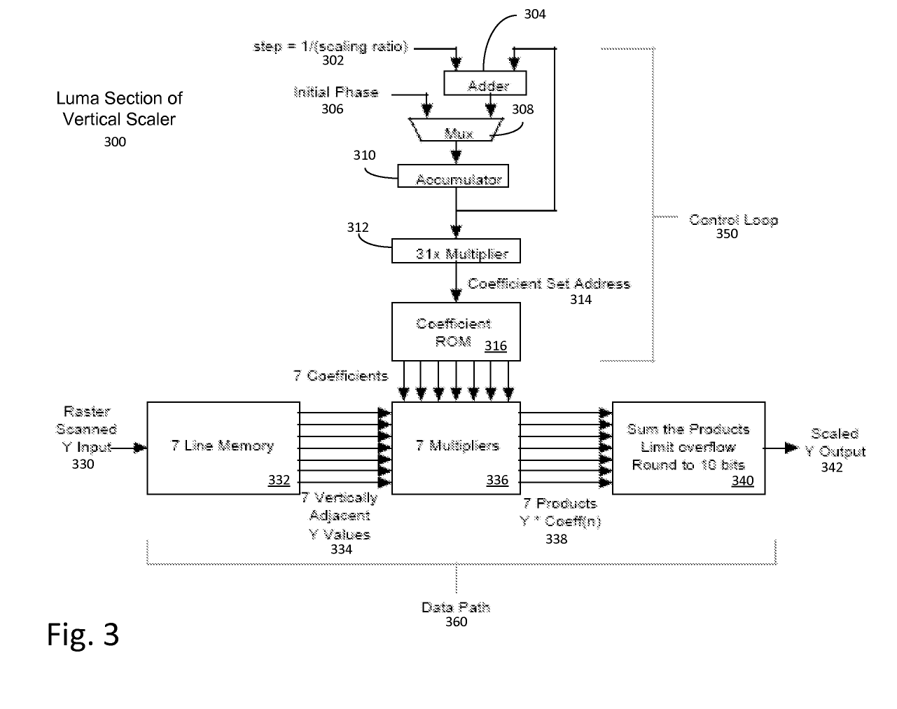

FIG. 3 illustrates of an embodiment of a section of a vertical scaler. In some embodiments, a luma section 300 of a vertical scaler, such as a poly-phase filter based scaler, includes a data path 360 and a control loop 350. The diagram provides the luma section of the vertical scaler. The scaler further includes a chroma section and a horizontal Y/C section, where such sections are similar to the illustrated luma section.

The control loop 350 includes an adder 304 with inputs of a step equaling the inverse of the appropriate scaling ratio 302, and a feedback value. An output of the adder 304 and an initial phase value for received data 306 are input to a multiplexer 308, with the chosen output of the multiplexer 308 being an input to an accumulator 310. An output of the accumulator 310 is the feedback value for the adder 304, and is an input to multiplier (a 31× multiplier in this example) 312, which produces a coefficient set address 314 for a coefficient ROM 316, to generate a set of coefficients, such as a set of poly-phase filter coefficients. While this illustration provides for obtaining coefficients from a ROM storage, scalers are not limited to this form, and may, for example, provide for the calculation of the set of coefficients.

In some embodiments, the data path 360 then receives a raster scanned Y input 330 at a seven-line memory 332, providing seven vertically adjacent Y values 334 for a set of seven multipliers 336, which further receives the set of coefficients from the coefficient ROM 316. The multipliers 336 generate a set of seven products (Y×coefficient (n)) 338. The set of products are summed (where, for example, the process may further include limiting overflow and rounding to a certain number, such as ten, bits) 340 to generate a scaled Y input 342.

In some embodiments, the scaler 300 further includes provisions for fitter ringing suppression. In some embodiments, the scaler 300 includes the generation of linear interpolation data, where the linear interpolation data being mixed with the poly-phase coefficients obtained from the coefficient ROM 316 to generate a set of blended coefficients. In some embodiments, the mixing of the coefficients may be made in accordance with a mixing control signal that is based on a rate of change in amplitude of the Y values 334. In some embodiments, the set of blended coefficients are provided to the multipliers 336 for use in generating the scaled output 342.

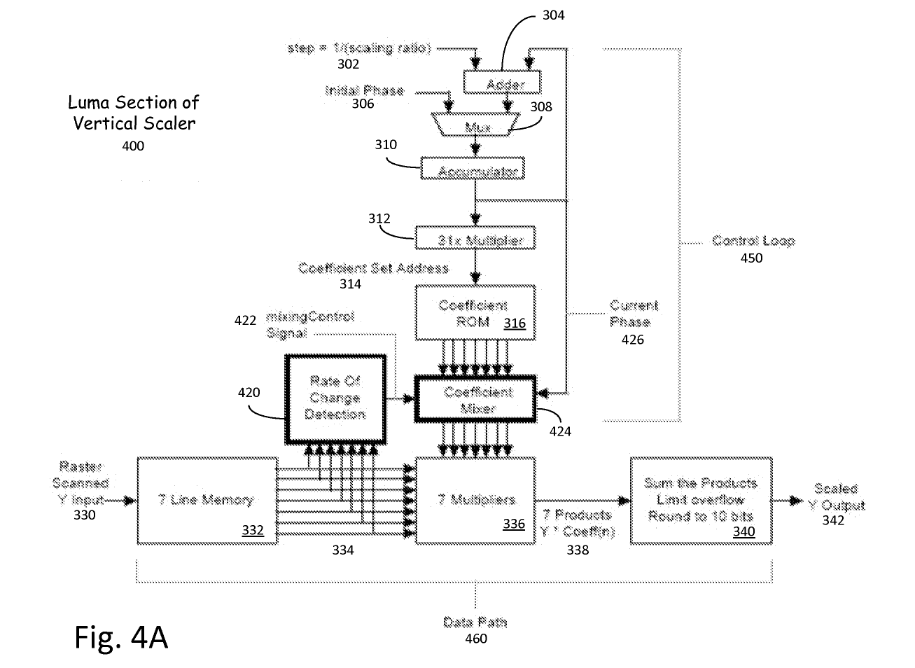

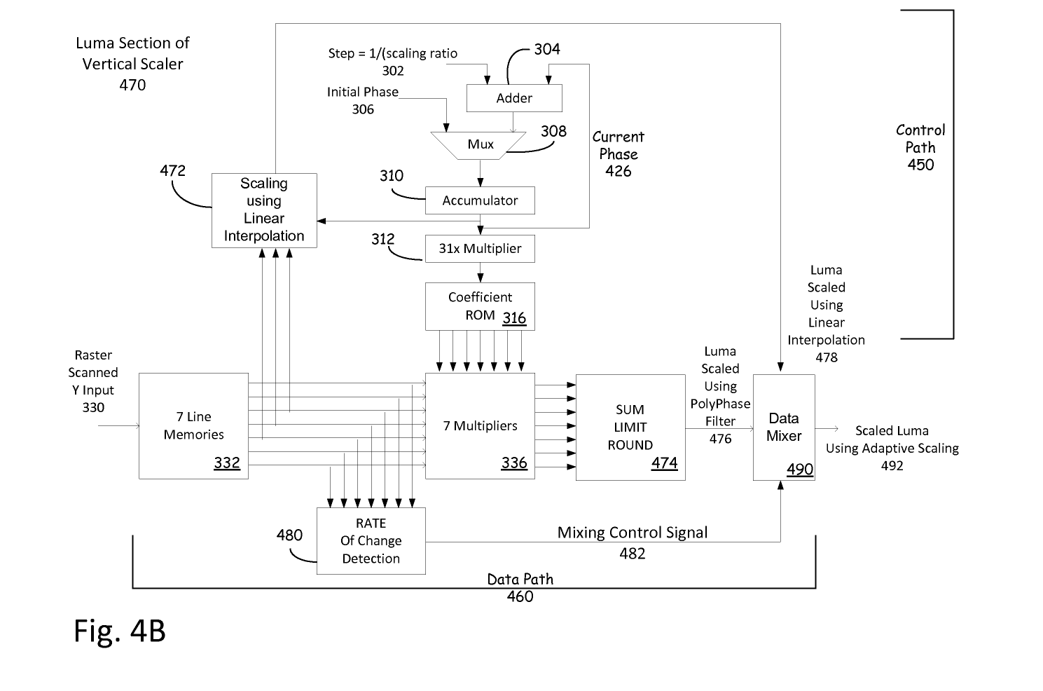

FIG. 4A illustrates an embodiment of a section of a vertical scaler including rate of change detection and coefficient mixing. In some embodiments, a luma section 400 of a vertical scaler includes a data path 460 and a control loop 450. In some embodiments, in addition to elements illustrated with regard to FIG. 3, in order to provide ringing suppression the control loop 450 further includes a rate of change detection module or element 420 to detect the rate of change of data from the data memory 332 and generate mixing control signals 422. In some embodiments, the rate of change module 420 analyzes the incoming Luma output of the line memories 332. In some embodiments, the rate of change module 420 operates to detect transitions that will cause filter ringing, the rate of change module generating the mixing control signal (mixingControl) 422 based at least in part on the rate of change detection. In some embodiments, the generation of the mixing control signal includes modification of the rate of change analysis, such modification based on as data contained in a software control register (not illustrated).

In some embodiments, the control loop 450 further includes a coefficient mixer module or element 424 to generate linear interpolation coefficients and to mix the linear interpolation coefficients with received poly-phase filter coefficients. In some embodiments, the coefficient mixer 424 receives the mixing control signal 422 from the rate of change detection module 420, filter coefficient data from the coefficient ROM 316, and current phase information 426 from the accumulator 310 for generation f linear interpolation coefficients. The coefficient mixer 424 mixes the filter coefficients to create blended filter characteristics. In some embodiments, the coefficient mixer 424 may operate to suppress ringing while maintaining overall performance. In some embodiments, the coefficient mixer module or element 424 includes one or more ringing control registers for use in calculating coefficient elements.

FIG. 4B illustrates an embodiment of a section of a vertical scaler including scalers operating in parallel. In some embodiments, a vertical scaler includes two scalers running in parallel. In such operation, a first scaler is a linear interpolator that uses the phase information from the accumulator to scale using linear interpolation, and a second scaler is a poly-phase filter. In some embodiments, logic of the vertical scaler generates a mixing control, but, rather than being utilized for mixing coefficients (such as provided in FIG. 4A), the mixing control is utilized for the mixing of data.

In some embodiments, a luma section 470 of a vertical scaler again includes a data path 460 and a control loop 450. In some embodiments, in addition to elements providing in FIG. 3, the luma section 470, rather than including a coefficient mixer (such as element 424 in FIG. 4A), includes a data mixer 490 to mix luma scaled using a polyphase filter 476 and luma scaled using linear interpolation to generate the scaled luma using adaptive scaling 492.

In some embodiments, the luma section 470 includes an element or module to provide scaling using linear interpolation 472, the element or module 472 receiving data input from the line memories 332 and the current phase 426 to generate the luma scaled using linear interpolation 478.

in some embodiments, the multiplier 336 are coupled with an element or module to provide for summed, limiting overflow, and rounding to a certain number of bits 474 to generate the ham scaled using the polyphase filter 476.

In some embodiments, a rate of change detection module 480 analyzes the incoming Luma output of the line memories 332 to generate a mixing control signal 482 based at least in part on the rate of change detection, the mixing control signal being presented to the data mixer to determine the mix of the luma scaled using the polyphase filter 476 and the luma scaled using linear interpolation 478 to generate the scaled luma using adaptive scaling 492.

While FIGS. 3, 4A, and 4B illustrate particular implementations of vertical scale containing certain elements or modules, embodiments of scalers are not limited to any particular numbers of such elements or modules. For example, the specific numbers of elements shown in FIGS. 3, 4A, and 4B, such as seven multipliers and thirty-one coefficient sets, are chosen based upon a particular balancing of factors such as performance and cost requirements. Other embodiments may use different numbers of such elements or modules if such factors are balanced in a different manner, such as to provide greater performance or to reduce costs.

FIG. 5 illustrates an embodiment of a portion of a rate of change detection module. In some embodiments, a rate of change detection module 500 in a module of a video scaler includes a portion providing for determination of a maximum difference between adjacent input values. In some embodiments, the detection module 500 receives multiple inputs 510, shown here as seven Y inputs denoted as Y0 through Y6. Y0 through Y6 are values that represent seven vertically adjacent Y values (for a vertical scaler) or seven horizontally adjacent Y values (for a horizontal scaler). While this illustration utilizes seven values, embodiments are not limited to any particular number of values.

in some embodiments, the detection module 500 determines the absolute value of the differences between adjacent Y values 520, such as Abs[Y1-Y0], Abs[Y2−Y1], and continuing through Abs[Y6−Y5]. In some embodiments, the determined difference values are provided to a maximum value function 530, where the maximum value function 530 determines which of the difference values is the greatest in value, and outputs a maxDifference value 540.

FIG. 6 illustrates an embodiment of a portion of a rate of change detection module. In some embodiments, a rate of change detection module 600 in a module of a video scaler includes a portion providing for determination of a sum of differences. In some embodiments, the detection module 600 receives multiple inputs 610, shown here seven Y inputs denoted as Y0 through Y6. In some embodiments, the detection module 600 determines the absolute value of the differences between adjacent Y values 620, such as Abs[Y1−Y0], Abs[Y2−Y1], and continuing through Abs[Y6−Y5]. In some embodiments, the determined difference values are provided to a summing function 630, where the summing function 630 determines a sum of the difference values, and outputs a differenceSum value 640.

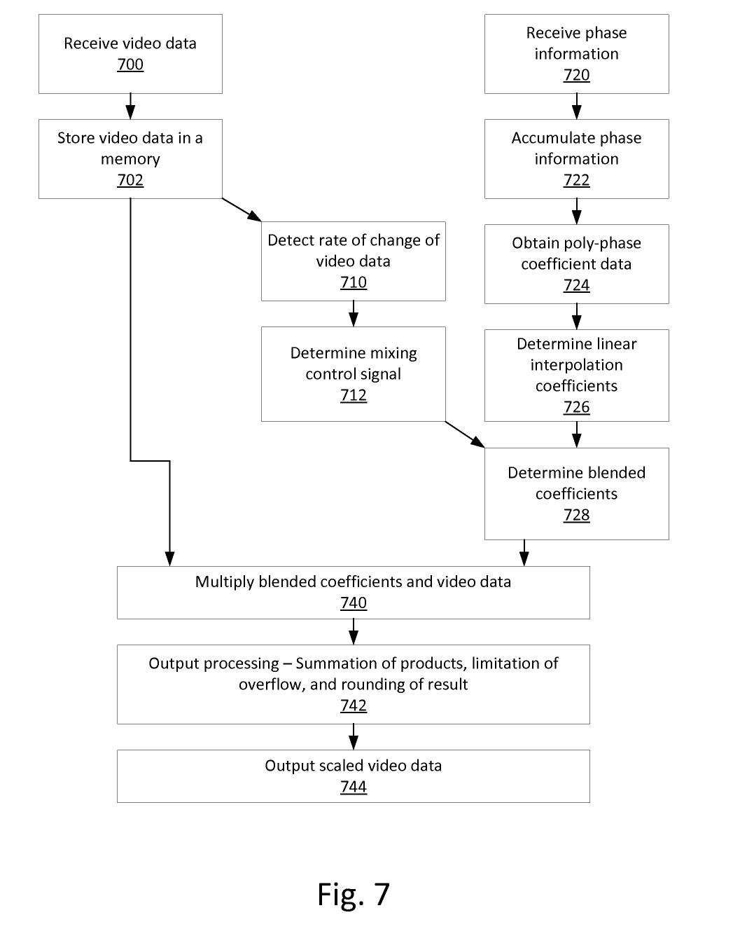

FIG. 7 is a flow chart to illustrate an embodiment of a process for generation of scaled video data. In some embodiments, video data is received 700 and the video data is stored in a memory 702. Further, in some embodiments, phase information is received 720 and the phase information is accumulated 722.

In some embodiments, rate of change of the video data obtained from the memory is detected 710, and, based on such rate of change, a mixing control signal is determined 712. In some embodiments, video scaling coefficient data, such as poly phase coefficient data, is obtained 724, and in addition linear interpolation coefficient data is determined based on the accumulated phase information 726.

In some embodiments, blended coefficients are determined 728, wherein the blended coefficients are based at least in part on the poly-phase coefficient data, the linear interpolation coefficient data, and the mixing control signal.

In some embodiments, the video data and blended coefficients are multiplied 740. The resulting product may be processed 742, including summation of products, limitation of overflow of results, and rounding of results, and the resulting scaled video data is output 744.

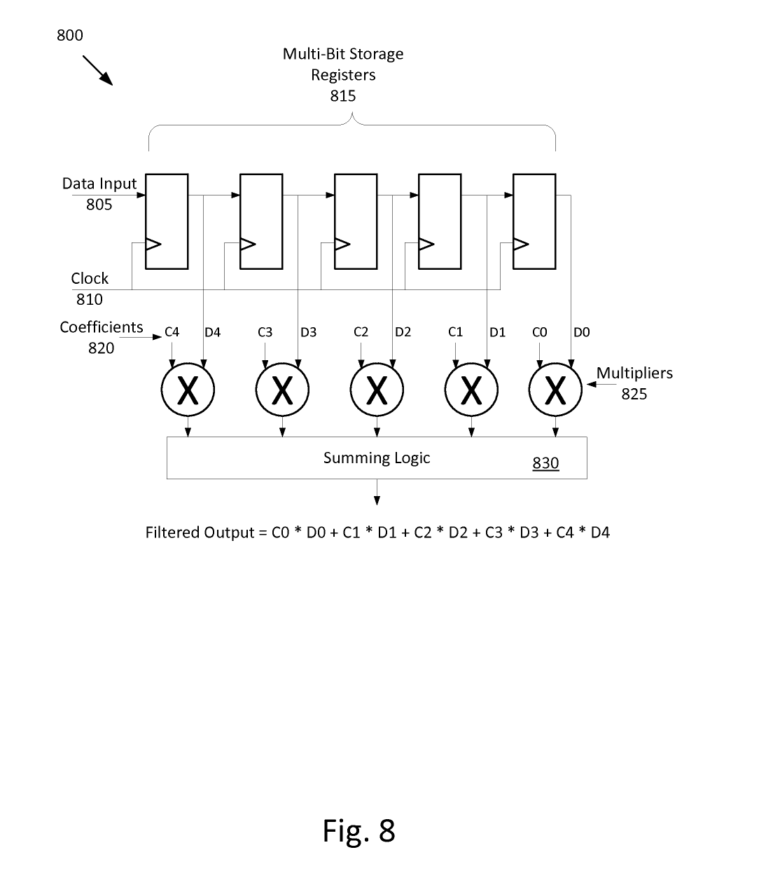

FIG. 8 illustrates an FIR digital filter in an embodiment of a scaling apparatus or system. In this illustration, an FIR digital filter has N=5, where N is the order of the fitter. In this illustration, a filter of order 5 is shown for simplicity. In practice, FIR filters often have much larger values of N. The value required for N depends on the selectivity requirement of the filter, and the performance requirements of the application. N may be an even or odd number, where either may be used to create low-pass filter responses. In this example and the discussion herein, N is an odd number.

As illustrated, the FIR digital filter includes a series of N connected multi-bit storage registers 815, wherein N=5 in this particular example. As shown, the series of registers 815 receive a data input 805 and a clock signal 810, with the data held by each of the first four registers being shifted in each clock cycle to a following register. The data output from each of the registers 815 is provided to a set of N multipliers 825, which multiply the data (shown as D0 through D4) times a set of N coefficients 820 (shown as C0 through D4). The products produced by the multipliers 825 are then provided to a summing logic 830 to produce a filtered output.

A new output from the filter 800 will be computed for each cycle of the clock. Each output of the filter F(out) thus is computed as:

F(out)=C0×D0+C1×D1+C2×D2+C3×D3+C4×D4,

Where:
F(out) is an output value of the filter,
C0, C1, C2, C3, C4=filter's coefficients, which are fixed values
D0, D1, D2, D3, D4=5 time adjacent samples of the incoming digital signal.

Basic elements of an FIR filter thus are a set of storage elements or registers, multipliers, coefficients, and summing logic, such as provided in FIG. 8. The storage elements may, for example, be registers that have a common clock and whose data ports are connected in series. Input samples are fed into this series of registers so that a time-adjacent set of samples is stored in the registers, and that the set of data samples shifts (from left to right in the illustration shown in FIG. 8) with each clock cycle, so that the data in the left register is the latest in time, and the data in the right register is the earliest.

For an N order low pass filter (N being an odd number in this example), the coefficients satisfy the following equation:

$$Coefficient ( n ) = 2 {f}_{c} \times \underline{sin ( n {ω}_{c} )} \vert \times ( n wf )$$

$$( n {ω}_{c} ) \vert$$

For n≠0

and

Coefficient(0)=2f_{c}

For n=0

Where

f_{c}=normalized cutoff frequency of the low pass litter

n=one of set N, ranging from −(N−1)/2<=n+(N−1)/2

[symbol] =2 Pi f_{c}

wf=a windowing function, such as a Hamming window

As described, the digital FIR filter produces a 1:1 ratio of input and output samples.

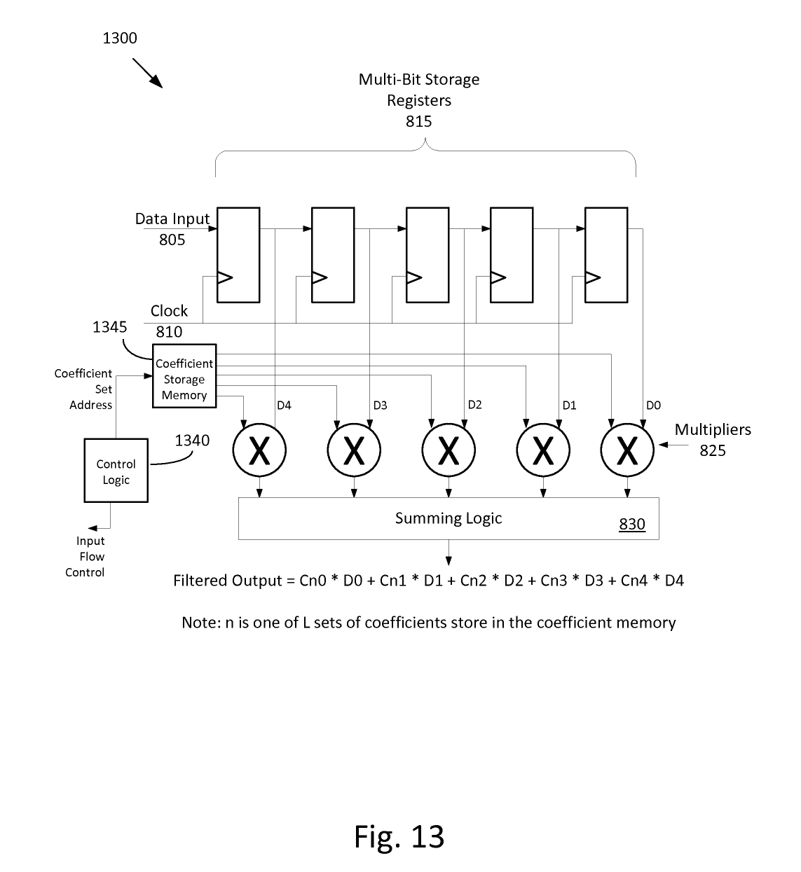

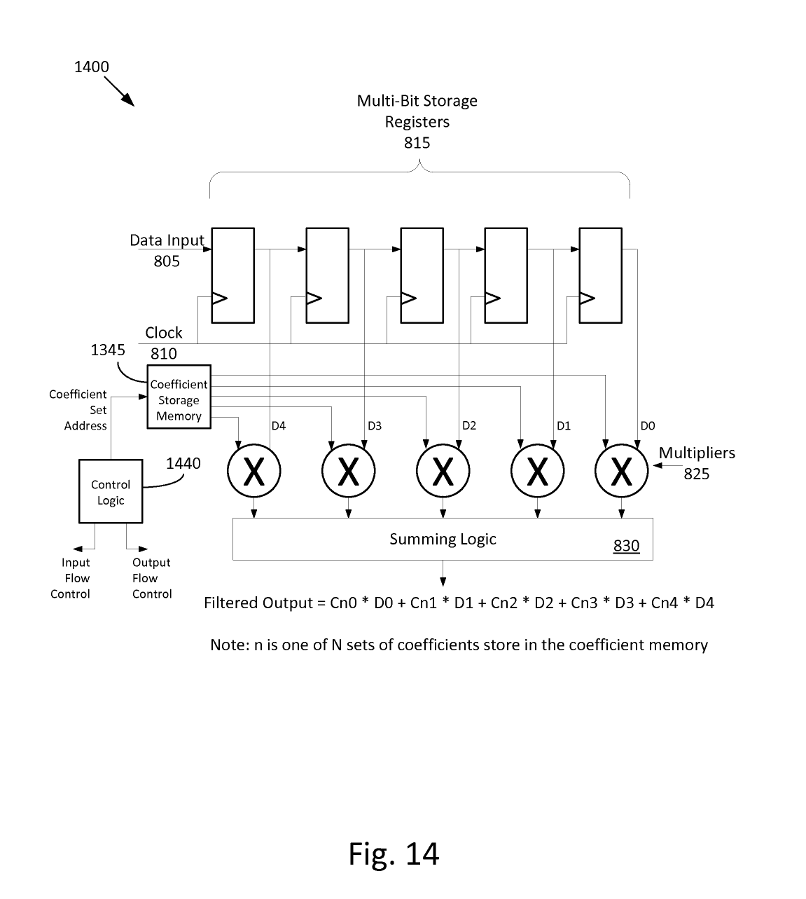

A polyphase FIR filter, such as filter 1300 illustrated in FIG. 13 and filter 1400 illustrated in FIG. 14, may be employed when there is a need to produce a different ratio of input to output samples, which is also known as sampling rate conversion. The two basic types of sampling rate conversion are interpolation and decimation. Interpolation is a type of sampling rate conversion in which the output rate is greater than the input rate, and decimation is a type of sampling conversion in which the output rate is less than the input rate. With regard to video scaling, interpolation is more commonly used for increasing the resolution of a video image, and decimation is used to decrease the resolution of a video image.

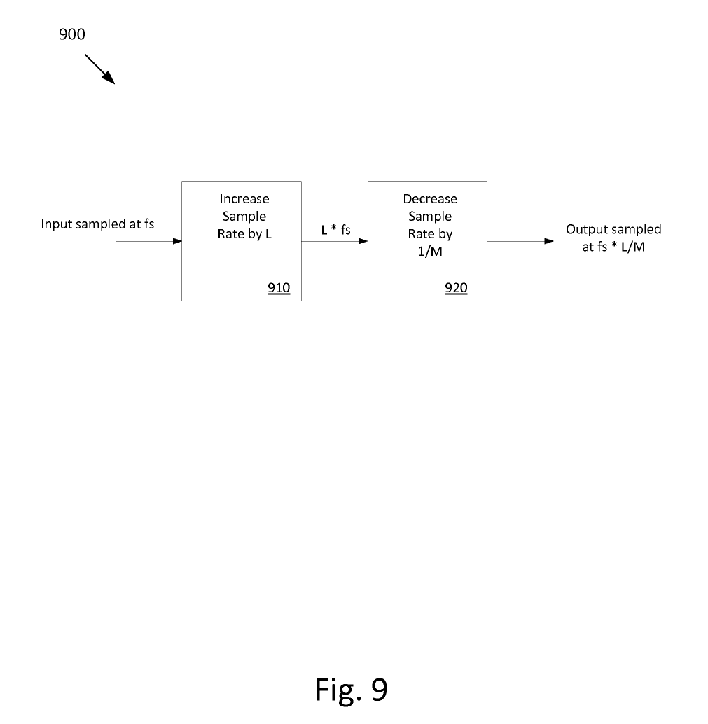

FIG. 9 illustrates modification of sampling rate in an embodiment of a video scaling process, apparatus, or system. In a scaling operation, there is a change in a scaling rate. A video scaler operates to change the sampling rate, and commonly the change is a Scaling Ratio (SR) described as a ratio of output samples to input samples:

SR=number of output samples/number of input samples

The SR may be assumed here to be one-dimensional, wherein there may be a horizontal SR and a vertical SR, but for the purpose of this description, the scaling ratio is SR. The term L/M is commonly used to describe the scaling ratio:

L/M=SR

where L and M are integers

Stated in another manner, L/M is a ratio of integers that specifies the Scaling Ratio SR. In FIG. 9, this is illustrated by an input that is sampled at a frequency fs being modified by a series of operations. In some embodiments, a first operation may be an increase in a sample rate by a value of L 910, resulting in a sample rate of L×fs, and a second operation may be a decrease in the sample rate by 1/M 920, resulting in an output that is sampled at a rate of fs×L/M.

FIR filters may be used to increase a sample rate by an integer multiple L. FIR filters may further be used to decrease a sample rate by 1/M, where M is an integer. The processing for doing rate conversions by L or 1/M is described below. Thus, changing a sample rate by a ratio of integers, L/M may be performed by connecting two FIR filter operations in series.

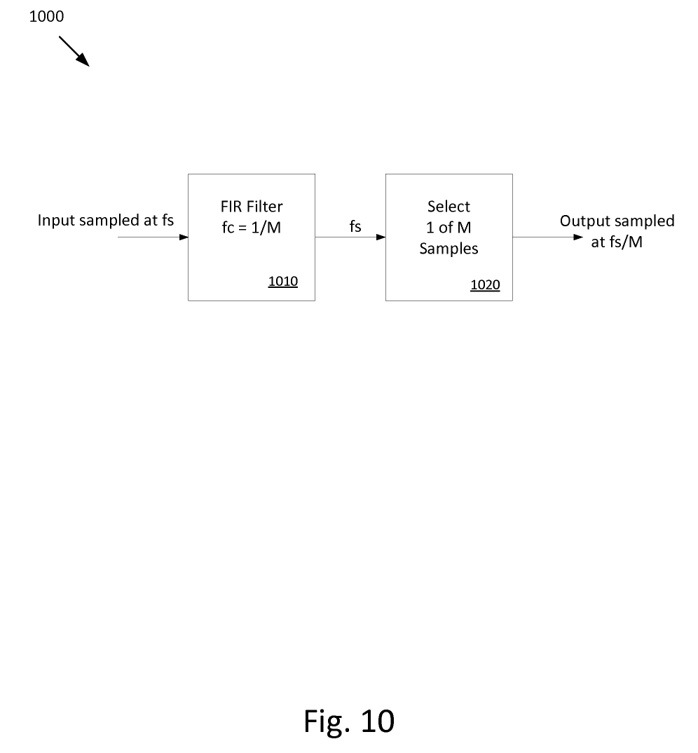

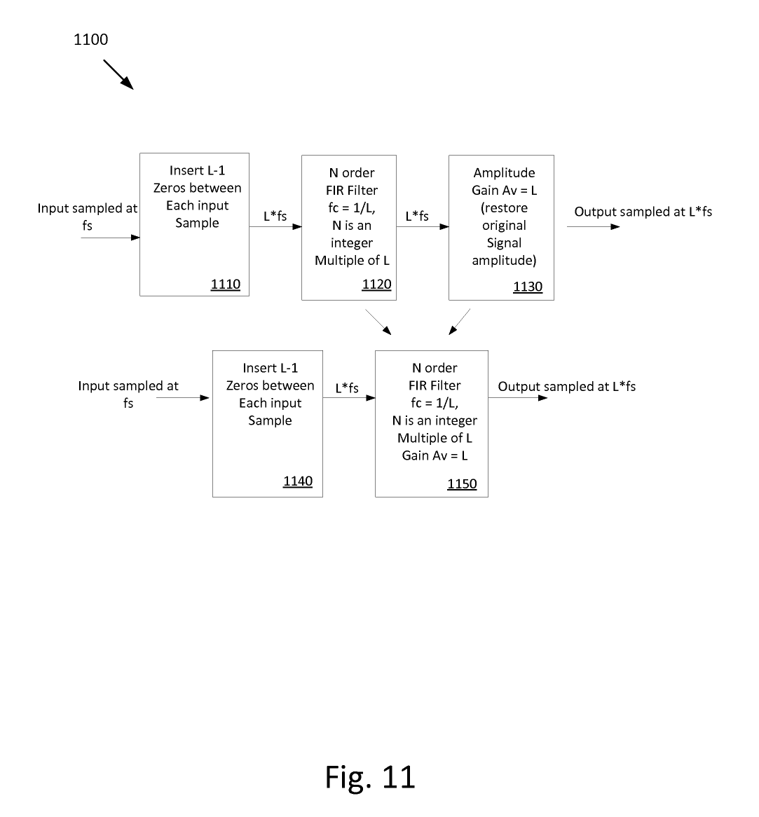

In some embodiments, a low pass FIR filter may be utilized for decimation by integer 1/M, and interpolation by integer L. In the illustrations shown in FIGS. 10 and 11, the two operations—increasing the sampling ratio by an integer multiple L and decreasing the sample rate by 1/M (where M is an integer)—are illustrated separately.

FIG. 10 illustrates modification of a sample rate of an FIR filter by decimation in an embodiment of a scaling process, apparatus, or system. Decimation reduces the sampling rate of a set of digital samples. Decimation by 1/M (where M is an integer) may be achieved using low pass FIR filters. In such operation, low pass filtering may be utilized to reduce the bandwidth of the sample stream to avoid abasing at lower sample rates of the output. This can be accomplished by, in one example, by using a low pass FIR filter designed using a using a normalized cutoff frequency of fc=0.5/M. However, embodiments are not limited to any particular choice of cutoff frequency.

In this illustration, a filter operation 1000 may be expressed by a series of operations to reduce the sample frequency, which may be included in a video scaling operation. In FIG. 10, input data is sampled using a sampling frequency fs. For FIR Filter 1010, fc=1/M. In sampling operation 1020, 1 of each M samples is chosen, resulting in an output sampled at fs/M.

FIG. 11 illustrates modification of a sample rate of an FIR filter by interpolation in an embodiment of a scaling process, apparatus, or system. Interpolation by an integer L may be accomplished using FIR filters. In this illustration, a filter operation 1100 may be expressed by an input sampled at fs being modified by the insertion of L−1 zeroes between each input sample 1110, resulting in a frequency of L×fs. The modified input is provided to an N-order FIR filter 1120 with cutoff frequency fc=1/L, where N is an integer multiple of L. The resulting data is modified by an amplitude gain operation 1130, where the gain average is L to restore the original signal amplitude, resulting in an output sampled at L×fs.

The operation may also be expressed as a filter operation in which the FIR filter 1120 and the amplitude gain operation are combined. In this illustration of the filter operation 1100, an input is again sampled at fs and modified by the insertion of L−1 zeroes between each input sample 1140, resulting in a frequency of L×fs. The modified input is provided to an N-order FIR filter 1150 with cutoff frequency fc=1/L and an amplitude gain operation of L, resulting in an output sampled at L times fs.

In an example, it may be presumed there is a requirement to increase the sample rate by 5, and Thus L=5. To design an FIR filter, a specification is required for the order of the filter, N, and its cutoff frequency fc. The order of a filter is dependent on the application and cost verses performance tradeoffs. In addition, for this specific application of increasing the sample rate by integer L, N may be chosen to be an integer multiple of L. For example, with L=5 and the order of the filter given as 25:

N=25

where L=5 and N=integer multiple of L

In this example, 25 is an odd number. In some embodiments, either an even or odd number may be used as the order of the filter in a process, apparatus, or system, as chosen by the designer. Processes for computing the filter's coefficients are slightly different if N is odd verses even, but persons of skill in the art will recognize that the same principles are utilized in even and odd order filters. In the examples that are provided here, N is an odd number.

With the order of the filter N and the cutoff frequency fc specified, the 25 coefficients for the low pass FIR filter can be computed using equations described earlier. The coefficients may be designated as C0, C1, C2 . . . C24, and the data that shifts into the filter may be designated as D0, D1, D2, D4 . . . .

To perform interpolation with a multiple of L, L−1 zeros are inserted between each data, sample, so the first 25 data values shifted into the filter's registers are as follows:

D4, 0, 0, 0, 0, D3, 0, 0, 0, 0, D2, 0, 0, 0, 0, D1, 0, 0, 0, 0, D0, 0, 0, 0, 0

At a point in time when the FIR filter has the data in its registers as shown above, the filter computes the first Filtered Output FO(0):

FO(0)=C24×D4+C23×0+C22×0+C21×0+C20×0+C19×D3+C18×0+C17×0+C16×0+C15×0+C14×D2+C13×0+C12×0+C11×0+C10×0+C9×D1+C8×0+C7×0+C6×0+C5×0+C4×D0+C3×0+C2×0+C1×0+C0×0

Next, the data shifts (to the right, in this description), such that the data in the filter's registers contain the following:

0, D4, 0, 0, 0, 0, D3, 0, 0, 0, 0, D2, 0, 0, 0, 0, D1, 0, 0, 0, 0, D0, 0, 0, 0

The next filtered output is as follows:

FO(1)=C24×0+C23×D4+C22×0+C21×0+C20×0+C19×0+C18×D3+C17×0+C16×0+C15×0+C14×0+C13×D2+C12×0+C11×0+C10×0+C9×0+C8×D1+C7×0+C6×0+C5×0+C4×0+C3×D0+C2×0+C1×0+C0

On the following clock cycles, data shifts to the right and the equations are a follows:

FO(2)=C24×0+C23×0+C22×D4+C21×0+C20×0+C19×0+C18×0+C17×D3+C16×0+C15×0+C14×0+C13×0+C12×D2+C11×0+c10×0+C9×0+C8×0+C7×D1+C6×0+C5×0+C4×0+C3×0+C2×D0+C1×0+C0×0

FO(3)=C24×0+C23×0+C22×0+C21×D4+C20×0+C19×0+C18×0+C17×0+C16×D3+C15×0C14×0+C13×0+C12×0+C11×D2+C10×0+C9×0+C8×0+C7×0+C6×D1+C5×0+C4×0+C3×0+C2×0+C1×D0+C0×0

FO(4)=C24×0+C23×0+C22×0+C21×0+C20×D4+C19×0+C18×0+C17×0+C16×0+C15×D3+C14×0+C13×0+C12×0+C11×0+C10×D2+C9×0+C8×0+C7×0+C6×0+C5×D1+C4×0+C3×0+C2×0+C1×0+C0×D0

At this point in processing, five outputs have been computed, and on the next clock, a new data sample D5 shifts in and D0 shifts out of the filter. The data in the registers is as follows:

D5, 0, 0, 0, 0, D4, 0, 0, 0, 0, D3, 0, 0, 0, 0, D2, 0, 0, 0, 0, D1, 0, 0, 0, 0

The equation for computation of FO(5) then is:

FO(5)=C24×D5+C23×0+C22×0+C21×0+C20×0+C19×D4+C18×0+C17×0+C16×0+C15×0+C14×D3+C13×0+C12×0+C11×0+C10×0+C9×D2+C8×0+C7×0+C6×0+C5×0+C4×D1+C3×0+C2×0+C1×0+C0

Based on this example it may be seen that added efficiency in calculations may be accomplished by noting that in all the equations for FO(0) . . . FO(5), 20 of the 25 products have zero terms for the data, and the result of these multiplications thus will be zero. Therefore, the equations above may be simplified by removing the product terms that contain zeros, as shown below for the first 6 FO outputs:

FO(0)=C24×D4+C19×D3+C14×D2+C9×D1+C4×D0

FO(1)=C23×D4+C18×D3+C13×D2+C8×D1+C3×D0

FO(2)=C22×D4+C17×D3+C12×D2+C7×D1+C2×D0

FO(3)=C21×D4+C16×D3+C11×D2+C6×D1+C1×D0

FO(4)=C20×D4+C15×D3+C10×D2+C5×D1+C0×D0

For FO(5), a new data sample D5 shifts in from the left, and D0 shifts out of the filter and is no longer used, as shown below:

FO(5)=C24×D5+C19×D4+C14×D3+C9×D2+C4×D1

It may be further observed that in the first five equations, the data terms were the same (D4 . . . D0), with only the coefficients changed, and the changes followed a clear pattern. The calculated filtered outputs will have significantly reduced signal amplitude relative to the input signal level, due to the summing of all the zero terms. The gain of an FIR filter is the sum of all its coefficients. Typically, the coefficients sum to 1, and the gain is 1. Thus, an amplitude gain is needed to restore a signal to its original amplitude level. In this specific example, a multiplier of 5 is needed because of the 4 to 1 ratio of product terms with zeros verses product terms with input data. In general, the required gain may be provided by multiplying each coefficient by L.

FIR filter coefficients may typically be pre-computed once and stored in a memory or register in hardware filter implementations such that the multiplication of each coefficient by L may be performed when the filter's coefficients are computed. Therefore, in some embodiments, a final set of 25 coefficients for a filter in a system may be as follows:

L×C0, L×C1, L×C2 . . . L×C24

As previously stated, an FIR filter used for interpolation may be designed such that the order (N) of the filter is a multiple of L, the interpolation integer. In the example, L=5, and N=25, where 25 is an integer multiple of 5. A reason for utilizing an order that is an integer multiple of the interpolation integer is to maintain the 1-to-(L−1) ratio of zeros to actual data samples in the FIR filter's data registers. In the example, L=5, and (L−1)=4 zeros were inserted between each of the data samples D(n). As the data shifts through the FIR filter's registers, the ratio of actual data samples and zeros is maintained if the order of the filter is a multiple of L.

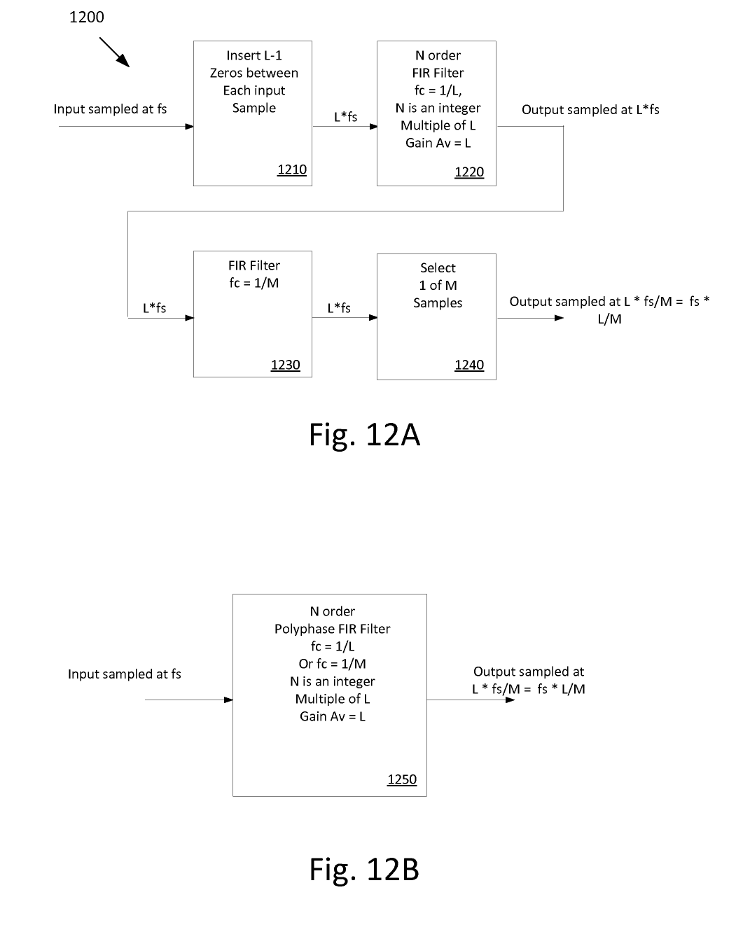

FIG. 12A illustrates modification of a filter operation by a sampling ratio in an embodiment of a system. In this illustration, a filter operation 1200 may be expressed by an input sampled at fs being modified by the insertion of L−1 zeroes between each input sample 1210, resulting in a frequency of L times fs. The modified input is to a first FIR filter, the filter being an N-order FIR filter 1220 with frequency fc=1/L and an amplitude gain operation of L, resulting in an output sampled at L times fs.

The output of the first FIR filter 1220 is provided to a second FIR filter 1230, the second FIR filter 1230 having a cutoff frequency of fc=1/M, in sampling operation 1240, of each M samples is chosen, decreasing the sample rate by 1/M, resulting in an output sampled at L×fs/M, or fs×sampling ratio L/M.

FIG. 12B illustrates a system for modification of a filter operation by a sampling ratio. In this illustration, a combined system to provide the operations of filter operation 1200. System 1250 includes an N-order polyphase FIR Filter, with cutoff frequency of fc=1/L, or fc=1/M. In such system, N is an integer multiple of L, and the system 1250 provides an average gain of L to compensate for the signal reduction.

FIGS. 12A and 12B illustrate the interpolation or decimation of data by a scaling ratio L/M. Operations for interpolation by integers L and decimation by 1/M where M is an integer are described above with regard to FIGS. 10 and 11. FIGS. 12A provides illustration of these two operations in combination, providing two FIR filters connected in series.

In some embodiments of a process, apparatus, or system connection of FIR filters in series presents an opportunity for additional efficiency. If the two filters both have a low-pass response, then only the filter with the lowest cutoff frequency may actually be needed because the operation of the other FIR filter is redundant. In some embodiments, the lowest cutoff frequency will depend on whether the sampling rate conversion is interpolation or decimation. If the sampling rate conversion provides for interpolation, the normalized cutoff frequency fc will be 1/L. If the sampling rate conversion provides for decimation, the lower cutoff frequency will be 1/M.

As described above, the insertion of L−1 zeros is not required if a filter's order is a multiple of L. This factor may be utilized to provide an additional simplification using the polyphase FIR organization.

With regard to providing a sampling rate converter using polyphase FIR filters, equations are presented in Table 1 below for FO outputs. These equations provide the series of computations being expanded, and with the rightmost column providing the coefficient set (CS). In this example, the value L=5 and the value for M=3, and thus the scaling ratio in this example is L/M=5/3,

TABLE 1

| | | |
|---|---|---|
| ++ | FO(0) = C24 × D4 + C19 × D3 + C14 × D2 + C9 × D1 + | CS 0 |
| | C4 × D0 | |
| | FO(1) = C23 × D4 + C18 × D3 + C13 × D2 + C8 × D1 + | CS 1 |
| | C3 × D0 | |
| | FO(2) = C22 × D4 + C17 × D3 + C12 × D2 + C7 × D1 + | CS 2 |
| | C2 × D0 | |
| ++ | FO(3) = C21 × D4 + C16 × D3 + C11 × D2 + C6 × D1 + | CS 3 |
| | C1 × D0 | |
| | FO(4) = C20 × D4 + C15 × D3 + C10 × D2 + C5 × D1 + | CS 4 |
| | C0 × D0 | |
| | FO(5) = C24 × D5 + C19 × D4 + C14 × D3 + C9 × D2 + | CS 0 |
| | C4 × D1 | |
| ++ | FO(6) = C23 × D5 + C18 × D4 + C13 × D3 + C8 × D2 + | CS 1 |
| | C3 × D1 | |
| | FO(7) = C22 × D5 + C17 × D4 + C12 × D3 + C7 × D2 + | CS 2 |
| | C2 × D1 | |
| | FO(8) = C21 × D5 + C16 × D4 + C11 × D3 + C6 × D2 + | CS 3 |
| | C1 × D1 | |
| ++ | FO(9) = C20 × D5 + C15 × D4 + C10 × D3 + C5 × D2 + | CS 4 |
| | C0 × D1 | |
| | FO(10) = C24 × D6 + C19 × D5 + C14 × D4 + C9 × D3 + | CS 0 |
| | C4 × D2 | |
| | FO(11) = C23 × D6 + C18 × D5 + C13 × D4 + C8 × D3 + | |
| | C3 × D2 | CS 1 |
| ++ | FO(12) = C22 × D6 + C17 × D5 + C12 × D4 + C7 × D3 + | CS 2 |
| | C2 × D2 | |

In Table 1, the first equation, the fourth equation, and each following third equation (designated as “++” and shown in bold type) represent 1/M (or ⅓ in this example) of the interpolated samples, where the interpolation integer L=5. In some embodiments, the remaining equations (h) non-bold type) do not need to be computed, the filter only requiring the computation of each third equation. In the bold equations, the coefficients are not used in a 0, 1, 2, 3, 4 sequence, but rather are in a 0, 3, 1, 4, 2 sequence. In some implementations, the data may be the same for two sequential outputs, and in some circumstances, only one output is computed from an input data set.

FIG. 13 illustrates a polyphase FIR digital filter providing input flow control in an embodiment of a scaling process, apparatus, or system. In this illustration, in addition to registers 815, multipliers 825, and summing logic 830, a polyphase FIR digital filter 1300 may include a coefficient storage memory 1345 to store coefficient values and control logic block 1340, the control logic 1340 providing input flow control. As illustrated in FIG. 13, control logic 1340 provides a coefficient set address to the coefficient storage memory 1345, where the coefficient set address may be used to choose one of a plurality of different sets of coefficients. In this illustration, a set n is chosen, whereby the multipliers 830 multiply values D0-D4 with coefficients Cn0 . . . Cn4.

In an example, an N-order FIR filter, such as an N=25 FIR filter used for interpolation, may be implemented as provided in FIG. 13. In this example, filter 1300 is a polyphase FIR filter with N=25. The coefficients are organized into five sets with five coefficients per set, and stored in a memory. The address to this memory is provided by the control logic block 1340. The input flow control generated by the control logic 1340 is used to control the inflow data rate, which is needed because the inflow rate is lower than the outflow rate.

FIG. 14 illustrates a polyphase FIR filter in an embodiment of a scaling process, apparatus, or system. The filter 1400 is similar to filter 1300 in FIG. 13, with a control logic block 1440 having an additional output signal, this output signal being an output flow control. In some embodiments, the output flow control is used to control the outputs of the polyphase FIR filter, in addition to controlling the input flow rate, as described with regard to control logic 1340 in FIG. 13. In some embodiments, the control logic 1440 cycles through the coefficient sets in the non-sequential order shown in the table of equations in the previous page (the equations indicated in bold).

Control logic produces flow control signals and the coefficient memory lookup address. If the scaling ratio is greater than 1, then the polyphase filter's output rate will be higher than the input rate. In this case, the control logic determines when to shift new samples into the registers. If the scaling ratio is less than 1, the filter's output rate will be less than the input rate. In this case, the control logic produces a signal that is used to disqualify the fitter's output during clock cycles in which the filter does not produce a valid output. In some embodiments, the control logic of a scaling system also generates an address for looking up a set of coefficients.

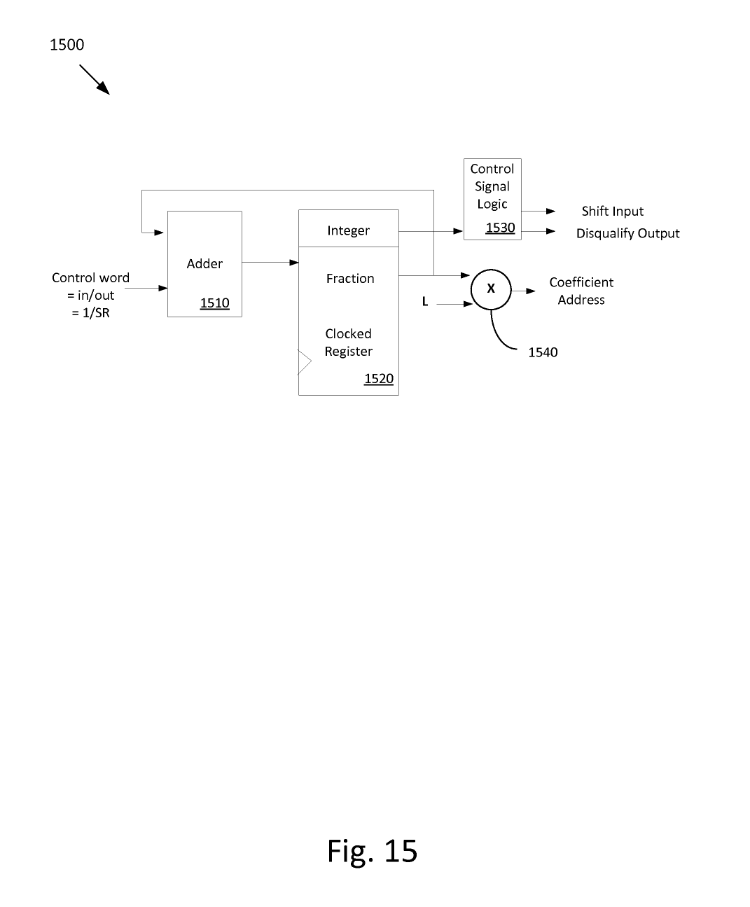

FIG. 15 illustrates a phase accumulator in embodiment of a video scaling process, apparatus, or system. In some embodiments, the control functions of a polyphase filter, such as the control functions of control logic 1340 in FIG. 13 and control logic 1440 in FIG. 14, may be produced using a phase accumulator 1500. The phase accumulator (or PA) 1500 includes a multi-bit clocked register 1520. An output of the register 1520 is provided to an adder 1510 as a first input. A second input to the adder 1510 is a control word. An output of the adder is fed back to an input of the register 1510, where the input is latched in the register 1520 on the next clock cycle.

As illustrated in FIG. 15, the control word (CW) is the reciprocal of the scaling ratio, and thus CW=1/SR. The control word may commonly be a multi-bit rational binary number. The binary number stored in the clocked register 1520 will have an integer part and a fractional part. The integer part of the stored binary number is received by control signal logic 1530, with the integer part being decoded and used for flow control, outputs of the control signal logic being a shift input and a disqualify output. The fractional part of the stored binary number is used to generate a coefficient address by multiplying (shown by multiplier 1540) the fractional part by the numerator of the scaling ratio, L.

In some embodiments, the clocked register 1520 is initialized with a starting value at the start of a video scaling operation. For vertical scaling, the register is initialized at the beginning of a video frame, and updated for each new output line. For horizontal scaling, the register is initialized at the start of a new horizontal line of output, and it is updated for each output sample.

In some embodiments, the binary value in the fractional part of the register 1520 tracks (or accumulates) the phase difference between the input and output sampling grids. This phase value may then be converted to a coefficient memory address by multiplying the fractional part by L.

In an operation, each update of the clocked register may result in a carry into the integer part of the register. The numerical value of this carry indicates how to shift new data into the video scaler's data registers (shift input). The numerical part of the carry also indicates when the output of the scaler's multipliers should be disqualified (disqualify output). The values operate as follows:

(0) If the carry into the integer part is 0, then no new data needs to be shifted into the data registers, and another output can be computed from the data currently in the registers. This will occur only in circumstances in which SR>1 (CW<1).

(1) However, if the carry into the integer part is 1, this carry value indicates “shift 1 new data set into the registers,”

(2) Further, if the carry into the integer part is 2, this carry value indicates “shift 2 new data sets into the registers, and disqualify the current output of the multipliers. Avaue of 2 or more will occur only in circumstances in which the SR<1 (CW>1).

For example, suppose the SR=L/M=5/3. The CW is 3/5=0.6, and the register is initialized with zero.

TABLE 2

| Accumulator | Fraction × 5 | | |
|---|---|---|---|
| Register | (L = 5) = | | |
| Value | Coefficient Value | Shift new data in? | Comment |
| 0.0 | 0 | No shift | Initialization |
| 0.6 | 3 | No shift | No change in |
| | | | integer |
| 1.2 | 1 | Shift 1 new data | Integer change = 1 |
| 1.8 | 4 | No shift | No change in |
| | | | integer |
| 2.4 | 2 | Shift 1 new data | Integer change = 1 |
| 3.0 | 0 | Shift 1 new data | Integer change = 1 |
| 3.6 | 3 | No shift | No change in |
| | | | integer |

The Coefficient Value column in Table 2 indicates the coefficient address cycles through addresses in the same order as the previous example, in which the coefficient sets were numbered in bold type:

coefficient set 0

coefficient set 3

coefficient set 1

coefficient set 4

coefficient set 2

in some embodiments of a video scaling process, apparatus, or system, a design maps the correct subset of coefficients to a particular address in the coefficient memory. The order of the coefficient set selection will be determined by the fractional part of the PA and the coefficient multiplier L.

Flow control can be seen in the example above, in which the change in the integer part determines whether to shift new data into the registers. If the scaling ratio SR is less than it such that 0.5<=SR<1, then the change in the integer part will always be 1 or 2. A “1” indicates that new data needs to be shifted in, and a “2” indicates that 2 new data should be shifted in, and that the current output of the multipliers should be disqualified (not a valid output sample).

Polyphase filters work well for scaling video in most cases, but are not perfect. FIR filters (including polyphase FIR filters) have a finite order (N) by necessity, and it is the finite nature of these structures that that result in distortions. Distortions caused by the finite nature of FIR filters are well known and are called Gibb's Phenomenon.

Gibb's phenomenon produces overshoots and undershoots in the output of an FIR filter when the input data stored in the fitter's registers includes a large transition over a small number of input samples As the transition becomes larger in amplitude, and the transition time smaller, the distortion becomes more apparent.

In video scalers based on the polyphase FIR filter, transitions that result distortion are rare when the video content is generated by a camera shooting a natural scene. However, computer generated graphics elements often include the kinds of features that causes distortion. In this context, “computer graphics elements” may include text and graphics images generated by computers, and it may also include graphics elements generated by consumer electronics equipment, such as BluRay and DVD players, and set top boxes. The graphics elements are generated by the menus and text that are overlaid onto video.

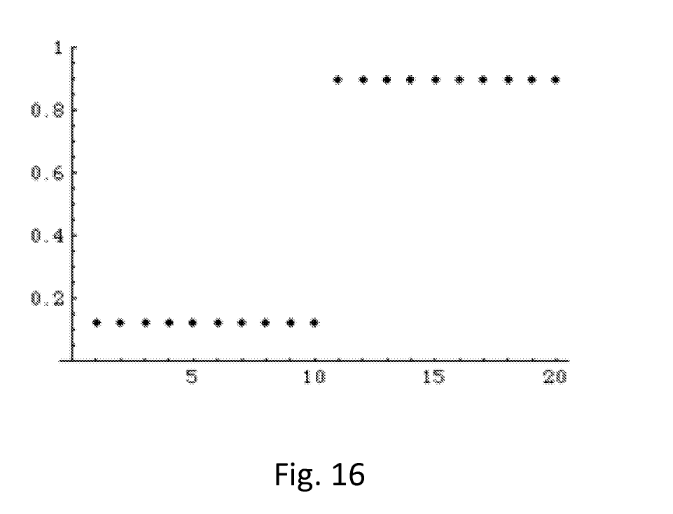

FIG. 16 illustrates a sequence of input samples to an embodiment of a video scaler. The amplitude of these samples has been normalized to the range 0>1, and the samples range from 0.1 to 0.9. However, these samples have an extremely abrupt transition, in which their value changes from 0.1 to 0.9. This is an example of the type of transition that is typical in computer graphics but is rare in natural images, and this kind of transition creates problems when scaled in a polyphase FIR filter.

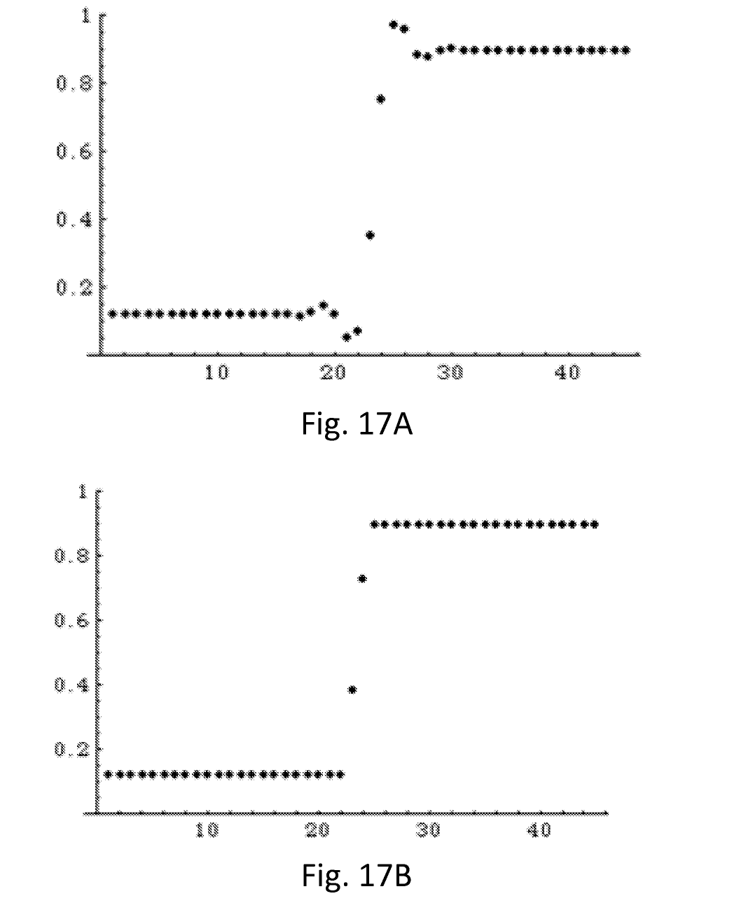

FIG. 17A illustrates an input sequence processed by a video scaler including a polyphase FIR filter. In this illustration, the input sequence provided in FIG. 17A is scaled using a polyphase FIR filter and a SR=9/4. In this illustration, the 20 input samples scaled by 9/4=45 output samples, which are shown in FIG. 17A. Overshoot and ringing are visible in the output samples on either side of the transition. These artifacts will be visible in a scaled video image.

FIG. 17B illustrates an input sequence processed by a video scaler including a linear interpolator. In contrast to FIG. 17A, the output samples shown in FIG. 17B are scaled by the same ratio using the same 20 samples illustrated in FIG. 16, except that such samples were scaled using a linear interpolator rather than a polyphase FIR filter. The overshoot and ringing visible in the polyphase filter's output in FIG. 17A are not apparent in the linear interpolator scaled output.

However, while the output of the linear interpolator provides an improvement over the polyphase FIR filter in this example of a discontinuity that is common in computer-generated images, the linear interpolator does a relatively poor job of scaling natural images, such as those generated by cameras. For natural images, the polyphase FIR technique produces a higher quality output image.

A linear interpolator provides a simple method for scaling an image if the phase relationship between an input and an output sample is known. In the example shown in FIG. 17B, the output is the simple average of two input samples.

In an example, an assumption may be made that phase information (P) is a value between 0 and 1, where 0 indicates an output phase matching input A and 1 indicates an output phase matching input sample B. Values of P such that 0<P<1 indicate a phase shift between A and B, wherein the output of a linear interpolator is the following:

LI(output)=(A×(1−P))+(B×P)

In some embodiments, the fractional part of the phase accumulator register, such as register 1520 illustrated in FIG. 15, contains phase information that may be used directly in computing the output for linear interpolator scaling. An adaptive scaling algorithm uses the output of the phase accumulator to suppress overshoot and ringing in a polyphase FIR video scaler. In some embodiments of a video scaler, the adaptive scaling algorithm blends polyphase FIR filter coefficients with phase information from the phase accumulator. In some embodiments, the blending is controlled by measuring rate of change (ROC) information in the set of data samples held in the polyphase filter's data registers. This rate of change information becomes the blending control for combining the 2 coefficient sets into a single set of coefficients.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs that are not illustrated or described. The illustrated elements or components may also be arranged in different arrangements or orders, including the reordering of any fields or the modification of field sizes.

The present invention may include various processes. The processes of the present invention may be performed by hardware components or may be embodied in computer-readable instructions, which may be used to cause a general purpose or special purpose processor or logic circuits programmed with the instructions to perform the processes. Alternatively, the processes may be performed by a combination of hardware and software.

Portions of the present invention may be provided as a computer program product, which may include anon-transitory computer-readable storage medium having stored thereon computer program instructions, which may be used to program a computer (or other electronic devices) to perform a process according to the present invention. The computer-readable storage medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/computer-readable medium suitable for storing electronic instructions. Moreover, the present invention may also be downloaded as a computer program product, wherein the program may be transferred from a remote computer to a requesting computer.

Many of the methods are described in their most basic form, but processes may be added to or deleted from any of the methods and information may be added or subtracted from any of the described messages without departing from the basic scope of the present invention. It will be apparent to those skilled in the art that many further modifications and adaptations may be made. The particular embodiments are not provided to limit the invention but to illustrate it.

If it is said that an element “A” is coupled to or with element “B,” element A may be directly coupled to element B or be indirectly coupled through, for example, element C. When the specification states that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B,” If the specification indicates that a component, feature, structure, process, or characteristic “may”, “might”, or “could” be included, that particular component, feature, structure, process, or characteristic is not required to be included. If the specification refers to “a” or “an” element, this does not mean there is only one of the described elements.

An embodiment is an implementation or example of the invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects.

What is claimed is:

1. A method for scaling of video data comprising:
receiving a stream of video data, the video data including a plurality of sets of video data values;
storing a first set of video data values from the steam of video data in a memory;
determining a first set of scaled values for the first set of video data values based on a scaling technology;
determining a second set of scaled values for the first set of video data values based on linear interpolation of the video data;
detecting a rate of change in amplitude for the received video data;
generating a mixing control signal based at least in part on the rate of change of the video data; and
mixing the first set of scaled values and the second set of scaled values based at least in part on the mixing control signal to generate a set of blended values; and
generating a scaled video data output using the set of blended values.

2. The method of claim 1, wherein the scaling technology includes poly-phase filter bank technology.

3. The method of claim 1, wherein the first set of scaled values is a first set of coefficients for the first set of video data values based on the scaling technology and the second set of scaled values is a second set of coefficients for the first set of video data values based on linear interpolation of the video data.

4. The method of claim 3, wherein the mixing includes mixing the first set of coefficients with the second set of coefficients based at least in part on the mixing control signal to generate a blended set of coefficients.

5. The method of claim 4, wherein determining the first set of coefficients includes one of retrieving the first set of coefficients from a memory or calculating the first set of coefficients.

6. The method of claim 4, further comprising computing a phase of the video data, wherein the determinations of the first and second sets of coefficients are based at least in part on the computation of the phase of the video data.

7. The method of claim 4, wherein the generation of the scaled video data includes multiplying the first set of video data values times the set of blended coefficients.

8. The method of claim 7, wherein the scaled video output generated using the blended set of coefficients has a level of filter ringing that is less than a level of filter ringing for a scaled video data output that would be generated using the first set of coefficients.

9. The method of claim 1, wherein the first set of scaled values is a first set of luma values for the first set of video data values scaled according to the scaling technology and the second set of scaled values is a second set of luma values for the first set of video data values scaled using linear interpolation of the video data.

10. The method of claim 9, wherein the mixing includes mixing the first set of luma values with the second set of liana based at least in part on the mixing control signal to generate scaled liana values.

11. The method of claim 1, wherein generating the mixing control signal includes determining a difference ratio between a maximum difference between adjacent values of the first set of video data values and a sum of the differences between the adjacent values of the first set of video data values.

12. The method of claim 11, wherein generating the mixing control signal includes multiplying the maximum difference between the adjacent values times the difference ratio times a predetermined register value.

13. An apparatus for scaling video data comprising:
a memory to store sets of video data values from a video data stream;
a scaled value determination portion to determine a first set of scaled values for the video data stream using a video scaling technology;
a detection element to determine a rate of change in amplitude of the video data stream and to determine a mixing control signal based on the determined rate of change; and
a mixing element to mix the first set of scaled values with a second set of scaled values based on linear interpolation to generate a set of blended values.

14. The apparatus of claim 13, wherein the video scaling technology is a poly-phase filter based technology.

15. The apparatus of claim 13, wherein the first scaled determination portion is a coefficient determination portion, the first set of scaled values being a first set of coefficients for the first set of video data values based on the scaling technology and the second set of scaled values being a second set of coefficients for the first set of video data values based on linear interpolation of the video data.

16. The apparatus of claim 15, wherein the mixing by the mixing element includes mixing the first set of coefficients with the second set of coefficients based at least in part on the mixing control signal to generate a blended set of coefficients.

17. The apparatus of claim 16, further comprising a plurality of multipliers to multiply the set of blended coefficients with a first set of video data values from the memory.

18. The apparatus of claim 16, further comprising an accumulator to accumulate phase data from the video data stream, the determination of the first set of coefficients and the second set of coefficients being based at least in part on phase data accumulated by the accumulator.

19. The apparatus of claim 16, wherein the coefficient determination portion includes a memory to hold coefficient values, wherein determination of the first set of coefficients includes obtaining coefficient values from the memory.

20. The apparatus of claim 16, further comprising an element to sum values generated by the plurality of multipliers and generate a scaled video output.

21. The apparatus of claim 13, wherein the first set of scaled values is a first set of luma values for the first set of video data values scaled according to the scaling technology and the second set of scaled values is a second set of luma values for the first set of video data values scaled using linear interpolation of the video data.

22. The apparatus of claim 21, wherein the mixing by the mixing element includes mixing the first set of luma values with the second set of luma based at least in part on the mixing control signal to generate scaled luma values.

23. The apparatus of claim 13, wherein generating the mixing control signal by the detection element includes determining a difference ratio between a maximum difference between adjacent video data values and a sum of the differences between the adjacent video data values.

24. The apparatus of claim 23, wherein the detection element includes at least one register to hold a predetermined register value, and wherein generating the mixing control signal includes multiplying the maximum difference between the adjacent values times the difference ratio times the predetermined register value.

25. A non-transitory computer-readable storage medium having stored thereon data representing sequences of instructions that, when executed by a processor, cause the processor to perform operations comprising:
receiving a stream of video data, the video data including a plurality of sets of video data values;
storing a first set of video data values from the steam of video data in a memory;
determining a first set of scaled values for the first set of video data values based on poly-phase filter technology;
determining a second set of scaled values for the first set of video data values based on linear interpolation of the video data;
detecting a rate of change in amplitude for the received video data;
generating a mixing control signal based at least in part on the rate of change of the video data; and
mixing the first set of scaled values and the second set of scaled values based at least in part on the mixing control signal to generate a set of blended values; and
generating a scaled video data output using the set of blended values.

26. The medium of claim 25, wherein the first set of scaled values is a first set of coefficients for the first set of video data values based on the scaling technology and the second set of scaled values is a second set of coefficients for the first set of video data values based on linear interpolation of the video data.

27. The medium of claim 26, wherein the mixing includes mixing the first set of coefficients with the second set of coefficients based at least in part on the mixing control signal to generate a blended set of coefficients.

28. The medium of claim 27, wherein determining the first set of coefficients includes one of retrieving the first set of coefficients from a memory or calculating the first set of coefficients.

29. The medium of claim 27, further comprising instructions that, when executed by the processor, cause the processor to perform operations comprising:
computing a phase of the video data, wherein the determinations of the first and second sets of coefficients are based at least in part on the computation of the phase of the video data.

30. The medium of claim 27, wherein the generation of the scaled video data includes multiplying the first set of video data values times the set of blended coefficients.
